(19) United States
(12) Patent Application Publication
(10) Pub. No.: US 2025/0097509 A1
(43) Pub. Date: Mar. 20, 2025

(54) SYSTEMS AND METHODS FOR A COMPUTING DEVICE MULTI-USER USER INTERFACE

(71) Applicant: Adeia Guides Inc., San Jose, CA (US)

(72) Inventors: Dhananjay Lal, Englewood, CO (US); Reda Harb, Tampa, FL (US)

(21) Appl. No.: 18/369,397

(22) Filed: Sep. 18, 2023

(51) Int. Cl. H04N 21/431; H04N 21/45

(52) U.S. Cl. CPC H04N 21/431; H04N 21/4532

(57) ABSTRACT

Systems and methods are provided herein for enabling the improved reception of multiple inputs at a user interface. A content item is received at a computing device, and metadata associated with the content item is received. A number of users that are in proximity to the computing device is determined, and an interactive content item is identified based on the metadata and the number of users. A visual representation of the users is accessed. A user interface is generated for output. The user interface comprises the interactive content item, which comprises at least one user interface element associated with each user, and the visual representation of the users. An input selecting a user interface element associated with each user is received. An indication of the received input and the user with whom the input is associated are stored to a data structure, and at least a part is transmitted.

One or more disclosed embodiments are directed towards systems and methods for enabling the improved reception of multiple inputs at a user interface. More particularly, systems and methods are provided herein that enable the identification of multiple users in proximity to a computing device, the generation of a user interface that indicates which user interface elements are assigned to each user, the reception of inputs selecting a user interface element for each user, and the storing and transmittal of the received inputs. Some embodiments or aspects relate to additional or alternative features, functionalities, and/or fields.

### SUMMARY

Consumer computing devices such as smart televisions, smartphones and tablet devices typically run applications associated with content providers, such as over-the-top (OTT) content item providers. A user logs in to an application, and the application enables content items, such as television programs, to be received via the internet and displayed at the computing device. A content provider application may also enable input associated with the content item to be received while the content item is being displayed. Typically, this input may be for controlling the content item, such as playing or pausing the content item; however, in other examples, the input may be utilized to choose different endings to a content item. The content provider application may also receive interactive content that may also be concurrently output with the content item, for example, as an overlay, and input may also be received at the content provider application in connection with this interactive content. The interactive content may comprise a survey, a poll and/or a bet associated with the content item being displayed, and the interactive content item may comprise a plurality of selectable user interface elements for indicating a response to the survey, poll and/or bet; however, when multiple users are viewing the same content item on the same computing device, it is not possible for multiple users to each provide a response to the survey, poll and/or bet, as typically only one user may log in to a content provider application at a time. As such, the content provider application does not have an indication of how many users are viewing a content item. Even if the content provider application did have an indication of how many users are viewing a content item, the content provider application would only be able to ascribe received inputs to a single user profile, rather than to each of the multiple users. In order to improve such systems, there is a need to provide a user interface that enables input to be received from multiple viewers of a content item, and to ascribe a received input to an identified viewer.

To overcome these problems, systems and methods are provided herein that enable the improved reception of multiple inputs at a user interface.

Systems and methods are described herein that enable the improved reception of multiple inputs at a user interface. In accordance with some aspects of the disclosure, a method is provided. The method includes receiving a content item at a computing device and accessing metadata associated with the content item. A number of one or more users that are in proximity to the computing device is determined, and an interactive content item is identified based on the metadata and the number of users. A visual representation of the one or more users is accessed, and a user interface is generated for output. The user interface comprises the interactive content item, which comprises at least one user interface element associated with each user, and the visual representation of the one or more users. An input selecting a user interface element associated with each user is received, an indication of the received input and the user with whom the input is associated are stored to a data structure, and at least a part of the data structure is transmitted.

In an example system, a sports program is received at a smart television from an OTT service provider, and metadata associated with the sports program is accessed at the smart television. In this example, the metadata is delivered to the smart television, from the OTT service provider, concurrently with the sports program. The smart television comprises an integrated camera, which is used to identify, for example, that three viewers are watching the sports program. An interactive poll is identified based on the accessed metadata and the identified number of viewers, with the poll querying which player in the game is the most valuable player. The interactive poll comprises three rows, one for each identified user, of selectable user interface elements, each row comprising the same set of answers to the query. A silhouette corresponding to the identified three users is identified, and a user interface comprising the poll, the user interface elements and the identified silhouette is displayed at the smart television. Inputs associated with the selectable user interface elements are received via a remote control associated with the smart television, and an indication of the inputs and a user associated with each input are stored at the smart television. The stored data is then transmitted, for example, to a remote server.

A manifest file comprising a link to the interactive content item may be generated, and the manifest file may be transmitted to the computing device. The manifest file may be accessed at the computing device, and the interactive content item may be retrieved via the link. Social media content associated with the content item may be identified based on the metadata, and identifying the interactive content item may further comprise identifying the interactive content item based on the social media content.

A capture of the one or more users may be received at the computing device, and a respective characteristic associated with each of the one or more users may be determined. Identifying the interactive content item may further comprise identifying the interactive content item based on the determined respective characteristics associated with the one or more users. A capture of the one or more users may be received at the computing device, and a fingerprint associated with the capture may be generated based on the capture. Identifying the interactive content item may further comprise identifying the interactive content item based on the fingerprint.

One or more of the users may be identified, and one or more user profiles may be accessed, each user profile associated with a respective user of the one or more identified users. Identifying the interactive content item may further comprise identifying the interactive content item based on the at least one of the accessed user profiles. One or more users may be determined in the visual representation, and a unique indicator may be applied to each determined user in the visual representation, and, for each determined user, a corresponding indicator may be applied to at least one of the one or more user interface elements associated with that user.

One or more of the users may be identified, and one or more user profiles may be accessed, where each user profile may be associated with a respective user of the one or more identified users. An associated computing device may be identified for each accessed user profile. For each associated computing device that is associated with an accessed user profile and respective user, generating the user interface for output may further comprise transmitting the at least one user interface element associated with the user to the associated computing device and generating for output the user interface comprising the user interface element associated with the user at the associated computing device. Receiving an input selecting a user interface element associated with each user may further comprise receiving an input associated with selecting a user interface element associated with the user at the associated computing device. Ambient audio may be captured via a microphone of an associated computing device, and audio associated with the content item may be identified. The captured ambient audio may be compared to the audio associated with the content item, and it may be identified that the captured ambient audio comprises the audio associated with the content item based on the comparing. It may be determined that the associated computing device is in proximity to the computing device in response to identifying that the captured ambient audio comprises the audio associated with the content item. A user interface element indicating an opportunity for the one or more users to interact with an associated computing device may be generated for output at the computing device.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example environment for enabling the improved reception of multiple inputs at a user interface, in accordance with some embodiments of the disclosure;

FIG. 2 shows an example architecture for enabling the improved reception of multiple inputs at a user interface, in accordance with some embodiments of the disclosure;

FIG. 3A shows an example user interface for enabling the improved reception of multiple inputs at a user interface in a first configuration, in accordance with some embodiments of the disclosure;

FIG. 3B shows the example user interface for enabling the improved reception of multiple inputs at a user interface in a second configuration, in accordance with some embodiments of the disclosure;

FIG. 4 shows a flowchart of illustrative steps involved in generating a user interface, in accordance with some embodiments of the disclosure;

FIG. 5 shows another example user interface for enabling the improved reception of multiple inputs at a user interface in a first configuration, in accordance with some embodiments of the disclosure;

FIG. 6 shows a flowchart of illustrative steps involved in enabling the improved reception of multiple inputs at a user interface, in accordance with some embodiments of the disclosure;

FIG. 7 shows another flowchart of illustrative steps involved in enabling the improved reception of multiple inputs at a user interface, in accordance with some embodiments of the disclosure;

FIG. 8 shows another example user interface for enabling the improved reception of multiple inputs at a user interface in a first configuration, in accordance with some embodiments of the disclosure;

FIG. 9 shows another flowchart of illustrative steps involved in enabling the improved reception of multiple inputs at a user interface, in accordance with some embodiments of the disclosure;

FIG. 10 shows a block diagram representing components of a computing system, and dataflow therebetween for enabling the improved reception of multiple inputs at a user interface, in accordance with some embodiments of the disclosure;

FIG. 11 shows another flowchart of illustrative steps involved in enabling the improved reception of multiple inputs at a user interface, in accordance with some embodiments of the disclosure; and

FIG. 12 shows another flowchart of illustrative steps involved in enabling the improved reception of multiple inputs at a user interface, in accordance with some embodiments of the disclosure.

### DETAILED DESCRIPTION

A content item includes audio, video, text and/or any other media content. A content item may be a single media content item; in other examples it may be a series (or season) of episodes of media content items. In a further example, a content item may comprise an advertisement or advertisements. Audio includes audio-only content, such as podcasts. Video includes audiovisual content such as movies and/or television programs. Text includes text-only content, such as event descriptions. One example of a suitable media content item is one that complies with the MPEG DASH standard. An OTT, streaming and/or video on demand (VOD) service (or platform) may be accessed via a website and/or an app running on a computing device and may receive any type of content item, including live content items and/or on-demand content items. Content items may, for example, be streamed to physical computing devices. In another example, content items may, for example, be streamed to virtual computing devices in, for example, a virtual environment and/or the metaverse. In another example, a content item may be a live, or broadcast, content item that is streamed via cable and/or terrestrial means.

A data structure includes any suitable data structure for storing and/or transmitting data. A data structure may comprise one or more of an array, a stack, a queue, a linked list, a tree, a heap, a graph, a keyword tree, a hash table and/or a map.

The disclosed methods and systems may be implemented on one or more computing devices. As referred to herein, the computing device can be any device comprising a processor and memory, for example, a television, a smart television, a set-top box, an integrated receiver decoder (IRD) for handling satellite television, a digital storage device, a digital media receiver (DMR), a digital media adapter (DMA), a streaming media device, a DVD player, a DVD recorder, a connected DVD player, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, a smartwatch, a smart speaker, an augmented reality headset, a mixed reality device, a virtual reality device, a gaming console, or any other television equipment, computing equipment, or wireless device, and/or combination of the same.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, USB drive, DVD, CD, media cards, register memory, processor caches, random access memory (RAM), a solid state drive, a NVMe drive and/or quantum memory, etc.

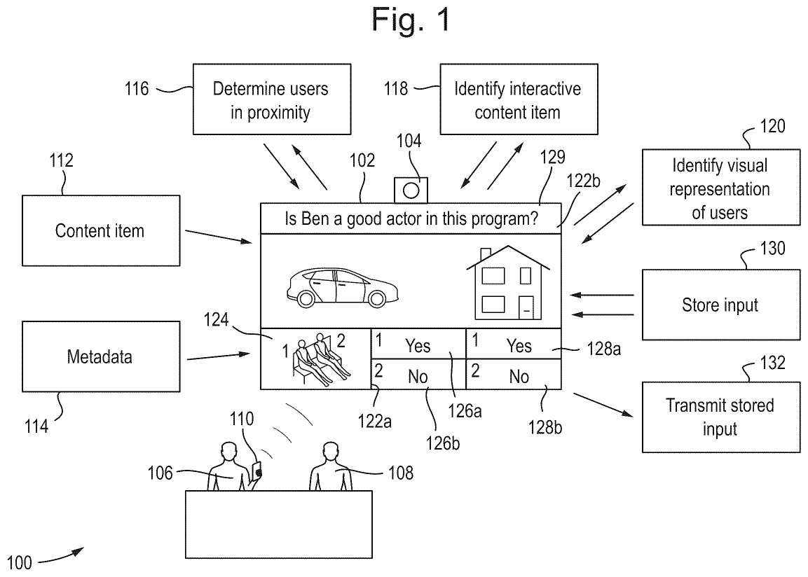

FIG. 1 shows an example environment for enabling the improved reception of multiple inputs at a user interface, in accordance with some embodiments of the disclosure. The environment 100 comprises a computing device, in this example, a smart (or connected) television 102; however, the computing device may be any suitable computing device including, for example, a smartphone or a tablet device. The computing device comprises a capture device. In this example, the smart television 102 comprises a camera 104; however, in other examples the capture device may be any device suitable for identifying a number of people proximate to the computing device. For example, the capture device may be a radar device, a LiDAR device and/or an infrared structured light device. The capture device is in communication with the computing device; in some examples, the capture device is integral to the computing device; in other examples, the capture device is separate from the computing device. The environment 100 also comprises, in this example, two users 106, 108 and an input device, which, in this example, is an infrared remote control 110 of the smart television 102; however, any suitable input device may be used such as a Bluetooth controller and/or Wi-Fi controller of the computing device. In another example, inputs may be received via a secondary computing device, such as a smartphone and/or tablet device (not shown). In some examples, the inputs may be received via a touchscreen of the computing device, a keyboard, a mouse and/or a microphone (not shown). In another example, the inputs may be received via a gesture detected at a touchscreen and/or an extended reality device (not shown). In this example, only one input device is shown; however, it is contemplated that each user may have their own input device and/or devices in other examples.

The smart television 102 receives 112 a content item, such as a program from an over-the-top content provider, and generates the content item for display at the smart television 102. Metadata associated with the content item is accessed 114. For example, the metadata may be integral to the content item, and may be received when the content item is received. In another example, the smart television may transmit, via a network such as the internet, a request to a service provider, and may receive the metadata in response to the request. The content item and the metadata may be received from, for example, the same physical and/or virtual server, or from different physical and/or virtual servers. The metadata may describe the contents of the content item including, for example, items, themes, actors, music, game scores, teams in a game and/or players in a game associated with the content item. In some examples, the metadata may also indicate timestamps of when any of the described contents occur in the content item.

A number of users in proximity to the smart television 102 is determined 116. This may comprise taking a capture of the immediate surroundings via the camera 104 and using image processing to identify the number of users in the capture. In this example, image processing may be used to identify that there are two users 106, 108 in front of the smart television 102. In some examples, a posture, or pose, of the users may also be identified via image processing. In further examples, items, such as a sofa that the users are sitting on, may also be identified via image processing. The image processing may take place at the smart television 102. In some examples the smart television may comprise a computer vision acceleration, which may include, for example, inferencing using artificial intelligence, neural network models and/or other algorithmic techniques. An artificial intelligence accelerator may also be utilized, such as a Qualcomm Snapdragon processor, a Google Tensor processor and/or a Samsung Exynos processor, which may be utilized in the image processing. In a further example, the capture may be transmitted to a secondary computing device, such as a remote server, via a network, and the image processing may be performed at the secondary computing device. The results of the image processing may then be transmitted back to the smart television 102.

An interactive content item is identified 118 based on the accessed metadata and the number of detected users. For example, an interactive content item may be identified that comprises user interface elements that enable each identified user to respond to a query related to the content item. A visual representation of the users is also accessed 120. In some examples, this may be a photo of the users. In other examples, the number of users and/or the users' poses may be matched to, for example, a stored silhouette. For example, it may be identified that a capture comprises two users sitting on a sofa, and a stored silhouette comprising two users sitting on a sofa may be accessed. The stored silhouette may not exactly represent the way the users are sitting, rather it may be a representation. In another example, a silhouette may be generated, substantially in real time, from the capture. In further examples, for each identified user, an image associated with a user profile, or a capture of a user's face may be shown in addition, or instead of a silhouette. In some examples, a combination of one or more silhouettes, images associated with user profiles and/or captures of users' faces may be shown. A number of users may be identified via computer vision and, in some examples, the computer vision may also identify specific users, in which case the system may use any suitable identification marker to indicate which user responds to which user interface element, or user interface elements.

A user interface comprising the interactive content item is generated for output at the smart television 102. In this example, the user interface comprises a first part 122a and a second part 122b; however, in other examples, the user interface may comprise a single part and/or any number of multiple parts. The first part 122a of the user interface comprises the identified representation of the users 124, and an interactive content item comprising a plurality of selectable user interface elements 126a, 126b, 128a, 128b for indicating an input. In use, a user provides input via the controller 110 to select a user interface element 126a, 126b, 128a, 128b. The user interface elements 126a, 126b, 128a, 128b may be arranged in a manner to indicate which user interface elements 126a, 126b are associated with a first user and which user interface elements 128a, 128b are associated with a second user. In some examples, the interactive content item may indicate which user interface elements are associated with each user, for example, via a number associated with each user on each of the selectable user interface elements for a user, and/or a color scheme associated with each user and each of the selectable user interface elements for a user. In this example, the second part 122b of the user interface comprises a query 129 that is based on metadata associated with the content item, for example, “Is Ben a good actor in this program?” The metadata may indicate, for example, that Ben is an actor in a current scene in the program.

The first user 106 uses the controller 110 to select a user interface element 126a associated with the first user, and the second user 108 uses the controller 110 to select a user interface element 128a associated with the second user. The input is received at the smart television 102 and is stored 130. For example, an indication of the received input and the user with whom the input is associated may be stored 130 in a data structure. At least a part of the stored input is transmitted 132. For example, the stored input may be transmitted 132 from the smart television 102 via a network, such as the internet, to a remote server. In this manner there is provided a user interface that enables input to be received from multiple viewers of a content item, and to ascribe a received input to an identified viewer.

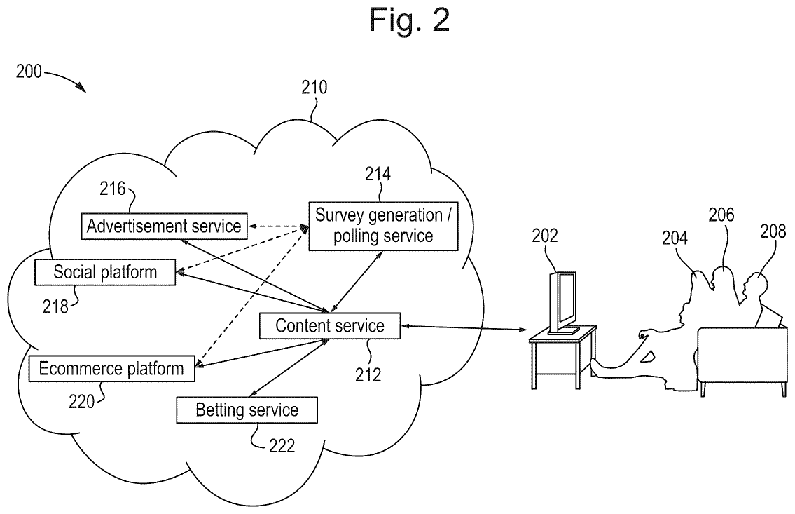

FIG. 2 shows an example architecture for enabling the improved reception of multiple inputs at a user interface, in accordance with some embodiments of the disclosure. The environment 200 comprises a computing device, in this example, smart (or connected) television 202, three users 204, 206, 208 and a plurality of cloud 210-connected services 212, 214, 216, 218, 220, 222, which are in communication with the smart television 202 and each other. The connected services comprise a content service 212, a survey generation and/or polling service 214, an advertisement service 216, a social platform 218, an ecommerce platform 220 and a betting service 222. Any number of these services and/or platforms may be present on the same physical or virtual servers, or may be present on separate physical or virtual servers. The smart television 202 communicates with the content service 212 via a network, such as the internet. The content service is in communication with each of the survey generation and/or polling service 214, the advertisement service 216, the social platform 218, the ecommerce platform 220 and the betting service 222. The survey generation and/or polling service 214 may also be in communication with the advertisement service 216, the social platform 218, the ecommerce platform 220 and the betting service 222.

As shown in FIG. 2, the content service 212 in the cloud establishes a connection with the smart television 202. The content service 212 may connect to the smart television 202 via a compatible client, such as an application associated with the content service 212, running on the smart television 202. The survey generation and/or polling service 214, the advertisement service 216 and the betting service 222 enable an interactive consumption experience to be provided at the smart television 202, where input with respect to feedback on a content item being consumed, input with respect to a poll and/or input with respect to a bet may be received at the smart television 202 and transmitted to an appropriate service. Each of the survey generation and/or polling service 214, the advertisement service 216 and the betting service 222 may be in communication with the smart television 202 to provide data that enables a user interface comprising an interactive content item to be generated for output. The interactive content item may comprise, for example, a poll and/or a bet that may be addressed to each identified viewer, or to an identified household. For example, the survey generation service 214 may generate surveys for individual secondary computing devices, such as, for example, smartphones and/or tablet devices, based on feedback received from the smart television 202 (e.g., the smart television 202 may transmit an indication of the number of viewers that can be surveyed to the survey generation service). In some examples, the survey generation and/or polling service 214, the advertisement service 216 and the betting service 222 may utilize software application programming interfaces (APIs) (e.g., representational state transfer (REST) APIs), to communicate with each other. In further examples, message broker software may be utilized to process events in the communication between the survey generation and/or polling service 214, the advertisement service 216 and the betting service 222.

The content service 212 may be an OTT service, or a distribution service such as a cable provider. In some examples, content may be delivered via an internet protocol (IP), thus allowing the content service 212 to determine the specific content being consumed, for example, via the smart television 202. Content may be unicast VOD content, or broadcast content using, for example, Advanced Television Systems Committee (ATSC) 3.0 or similar. In some examples, the content service 212 may be implemented in a specific location, such as a home, using an OTT client application, or an IP-based set-top box. The content service 212 establishes a session with the survey service 214 and informs the survey service 214 of survey opportunities, based, for example, on a current channel program or a VOD program currently being consumed at the smart television 202. For example, an opportunity may exist if an advertisement is to be served before or during a news show. The metadata of the news show may thus become the driver to establish a session. The network or broadcaster may enable surveys or polling for a particular show, such as the news show, or during specific periods of a show, for example, while interviewing a candidate for a political office (e.g., a presidential candidate), or during a sports game. The survey service 214 may also utilize a communication protocol with the advertisement service 216 to display a poll during an advertisement. In some examples, a video analysis service, typically co-located with the content service 212, may analyze the content at ingestion to determine whether a survey can be generated.

In another example, the advertisement service 216 may indicate whether a particular advertisement should be served with or without a survey. For example, the advertisement service 216 can make a determination as to whether an advertisement should be served with or without a survey after it receives data on how many viewers, or users, are in proximity to the smart television 202, or are present at a specific location, such as a household. The advertiser, depending on a brand and/or product, may target households based on different criteria. For example, an advertiser may target a single viewer or many viewers, the sex of a viewer, the age of a viewer and/or based on a user profile incorporating social media and/or purchasing habits.

In some examples, a computer vision-based artificial intelligence and/or machine learning model may be utilized to identify a number viewers proximate to the smart television 202, or in a specific location, such as a household, and the correlation of these viewers with identified content service profiles may yield information on who is watching and their preferences. If a survey is to be served with an advertisement, then the media asset manifest file may be manipulated to include a link to the survey so that the client can retrieve it using a protocol such as hypertext transfer protocol (HTTP) or HTTP secure (HTTPS). The manifest file may be manipulated to insert one or more advertisements in an advertisement pod with the generation of a survey, and link the generated survey to a particular advertisement and/or period in an advertisement, or content item, as well as inserting links to the advertisement segments in the manifest file.

The display of a survey or poll may occur at any point while an advertisement is being consumed, or after an advertisement finishes. In one example, during live television consumption, advertisements with surveys are displayed first in an advertisement pod, or break, since the duration of the user response may determine whether to display other advertisements from an advertisement pod during the advertisement break, or to return to the live television. The survey service 214 may be a third-party service, or it may be offered by a service provider, for example, integrated with the content service 212. The survey service 214 may be responsible for dynamically constructing a survey based on a template it receives from an advertiser or content service 212. For example, an advertiser may request a survey for one advertisement in a pod of advertisements, and may specify criteria such as “How likely are you to recommend the products advertised?” or “Do you use these products being advertised?” The advertiser may provide a survey link to the content service 212 and/or the advertisement service 216 that is transmitted to the smart television 202. The advertiser may generate a separate link for each viewer proximate to the smart television 202, or in a specific location, such as in a household, to capture responses for cross-tabulation analysis with individual user profiles. In some examples, the advertisement service 216 may determine whether to poll the household as opposed to individual viewers based on the advertisement type and/or brand. For example, a survey about a sports utility vehicle advertisement may be applicable to a household in general as opposed to individual people in that household. In other examples, advertisers might elicit feedback from viewers in exchange for coupons and/or discounts.

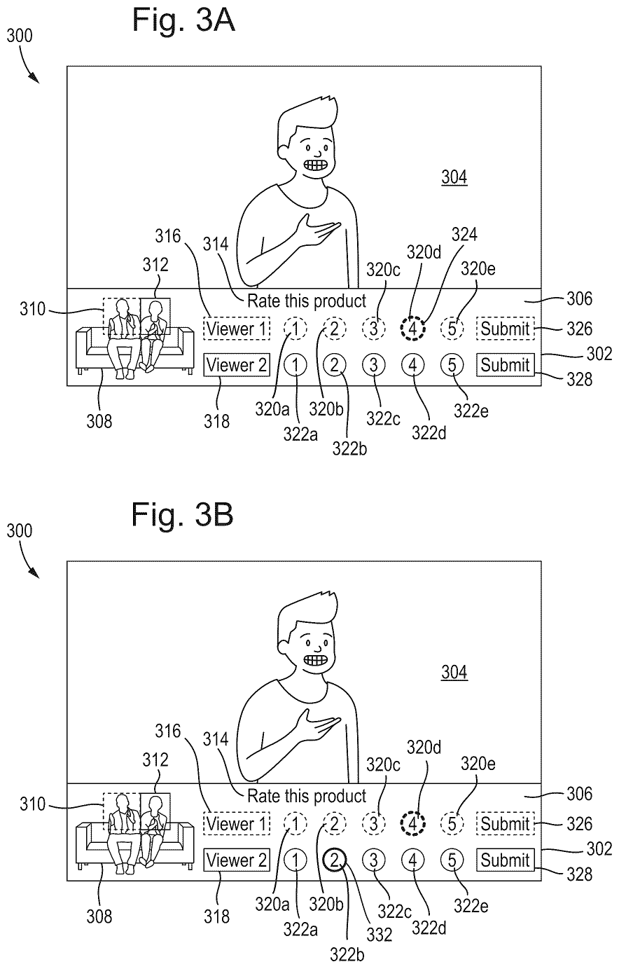

FIG. 3A shows an example user interface for enabling the improved reception of multiple inputs at a user interface in a first configuration, in accordance with some embodiments of the disclosure. The environment 300 comprises a computing device, such as a smart television 302. The smart television 302 generates a content item 304 and a user interface 306 for output. The user interface 306 comprises a representation 308 of the users proximate to the smart television 302 (for example, those identified in a capture taken by a camera in communication with the smart television 302 (not shown)). The representation 308 comprises first and second indicators 310, 312 for indicating the first and second users present in the representation 308. The indicators 310, 312 may be unique indicators, for example they may be indicators that are different colors and/or have different line styles, such as solid and/or dashed lines. In this example, the representation is a matched silhouette, based on a capture received at the smart television 302. Although two users are shown here, any number of users may be indicated, for example, one, three, five or 10 users. In this example, the indication also includes a representation of furniture (i.e., a sofa) that the users are sitting on and a pose of the users (i.e., sitting down); however, the indication of the furniture and the user poses are both optional. The user interface 306 also comprises a prompt and/or query 314, in this example, “Rate this product,” an interactive content item comprising indications 316, 318 of the first and second users, a plurality of selectable user interface elements 320a-e, 322a-e for rating the product, and selectable user interface elements 326, 328 for submitting a selected rating. If more or fewer users are identified as being proximate to the smart television 302, additional (or fewer) rows of user indicators and user interface elements are generated as appropriate. In this example, input associated with selecting a rating of “4” on the row associated with “Viewer 1” is provided, as indicated by the thicker border 324 around the corresponding selectable user interface element 320d. On selecting “Submit” 326, the rating and an indication of the user are stored, for example, to a data structure.

FIG. 3B shows the example user interface for enabling the improved reception of multiple inputs at a user interface in a second configuration, in accordance with some embodiments of the disclosure. FIG. 3B shows how user interface 306 changes after the “Submit” user interface element 326 associated with “Viewer 1” is selected. User interface elements 316, 320a-e, 326 are generated for output in a duller color 330. This makes it more obvious that the user interface is now configured to receive input associated with “Viewer 2.” In this example, input associated with selecting a rating of “2” on the row associated with “Viewer 2” is provided, as indicated by the thicker border 332 around the corresponding selectable user interface element 322b. On selecting “Submit” 328, the rating and an indication of the user are stored, for example, to a data structure. In some examples, the indicators 310, 312 may be selectable, such that the focus of the user interface changes to indicate that input can be provided that is associated with a particular viewer.

When a polling opportunity is determined, for example, via video analysis, the content service 212 or advertisement service 216 may query the smart (or connected) television 302 for a capture, such as an image received via a front-facing camera (not shown) of the smart television 302, for analysis. In some examples, the smart television 302 may not provide an image to services remote from the smart television 302, such as the content service 212 or advertisement service 216; however, the smart television 302 may instead return parameters, such as a fingerprint, through an analysis of the capture that informs a decision on what polling question to present. For example, the analysis of the capture may be used to generate a unique fingerprint that is associated with that capture and/or set of identified features in the capture. For example, a capture of two users sitting down may always generate the same fingerprint. In some examples, such parameters are returned at the beginning of a content item (e.g., when playback is initiated, or when the smart television 302 starts receiving a unicast VOD and/or a multicast associated with a channel). This may aid the advertisement service 216 in making advertisement decisions at the beginning of media playback.

In other examples, such parameters may be updated during a content item. For example, an audience tracker component (implemented partially on the smart television 302) may reinitiate the process after a predetermined amount of time, or before requesting an advertisement (e.g., in the case of real-time advertisement bidding). The audience tracker component may also reactivate to confirm and/or to verify measurements (e.g., after outputting the advertisement).

In an example when the polling service 214 generates a single poll for multiple viewers, the polling service 214 may have a template related to choosing a polling question. In some examples, the polling service 214 may use a dominant viewer profile (for example, a viewer who has the greatest viewing time on the service and/or the most significant purchasing history) from a plurality of identified viewers to determine a polling question. In other examples, the polling service 214 may determine a polling question based on an aggregate of preferences of multiple identified viewers.

The smart television 302 may transmit a capture, such as an image, of the area in front of it, to an appropriate service, which analyzes the capture. In this example, the service determines that there are two viewers in front of the smart television 302 (other profile information, such as the sex of the viewers and the precise identities of the viewers may also be determined). In this example, the survey generation service 214 generates a poll that asks the same question of both viewers (e.g., to rate the product, or to assess a character in a reality television show). As shown in FIG. 3A, the system may use visual cues to direct each user to their respective user interface elements. In some examples, the capture from the front-facing camera of the smart television 302 may be presented (optionally processed, for example, by applying a style filter) in a user interface output at the smart television 302. Person detection may be applied to the capture, and boxes in separate colors may be applied to, for example, the head of each viewer to denote each viewer. The same colors may be utilized for user interface elements associated with each viewer.

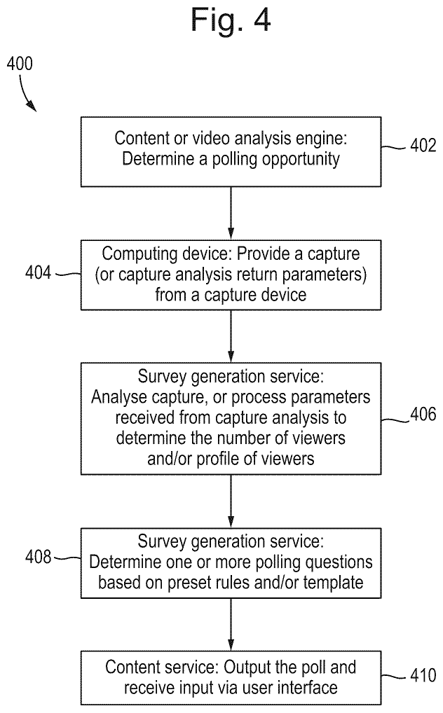

FIG. 4 shows a flowchart of illustrative steps involved in generating a user interface, in accordance with some embodiments of the disclosure. Process 400 may be implemented, in whole or in part, on any of the aforementioned computing devices (e.g., computing devices 102, 202, 302 e.g., by way of executing one or more instructions or routines stored in the memory or storage of a device). In addition, one or more actions of the process 400 may be incorporated into or combined with one or more actions of any other process or embodiments described herein. At 402, a content or video analysis engine (or advertisement service) determines a

polling opportunity, and at 404, a computing device provides a capture (or capture analysis return parameters) from a capture device (for example, an image from a front-facing camera associated with a computing device, such as smart television 302). At 406, a survey generation service analyzes the capture (such as the aforementioned image), or processes parameters received from the capture analysis to determine a number of viewers and/or a profile of the identified viewers. At 408, the survey generation service determines one or more polling questions based on preset rules and/or a template, and at 410, a content service outputs the poll and receives input via a user interface at, for example, the smart television 302. The input may, for example, be input received from each of the users identified in step 406.

In one example, the survey generation service generates polls for a content item such as a reality television show, with questions to determine the show's popularity, the popularity of a character in the show, or how popular a character is on social media. In some examples, the poll results may also be shared via a social media profile (e.g., the poll results may be posted on a social media page belonging to a show, channel, service and/or a member of the show cast). Polls with respect to brands and/or products may also be generated, and the results of such polls may be posted to ecommerce sites, or presented in new advertisement, such as in a portion of a user interface generated for output at the smart television screen to inform the viewers of previous poll results.

In another example, the survey component may interface with a social media network (e.g., X, formally known as Twitter) to retrieve posts relating to a particular show (for example, a social media network may enable third parties to download posts for analysis via, for example, an API). The social media network may also allow their users (e.g., verified accounts or known influencers) to indicate on their profile, or by other means, to the survey system that they wish to poll viewers when they are mentioned in a content item (e.g., on a news program), or when a show or movie they are featured in is playing on television. Such a profile may also define the polling subject (e.g., likes, dislikes and/or a new hair style). This enables the polling system to generate polls dynamically based on a social media account, and the user to provide survey criteria. In a further example, metadata associated with an electronic programming guide (EPG) may include criteria, such as social media network profile criteria, which may be used by the polling service to generate polls.

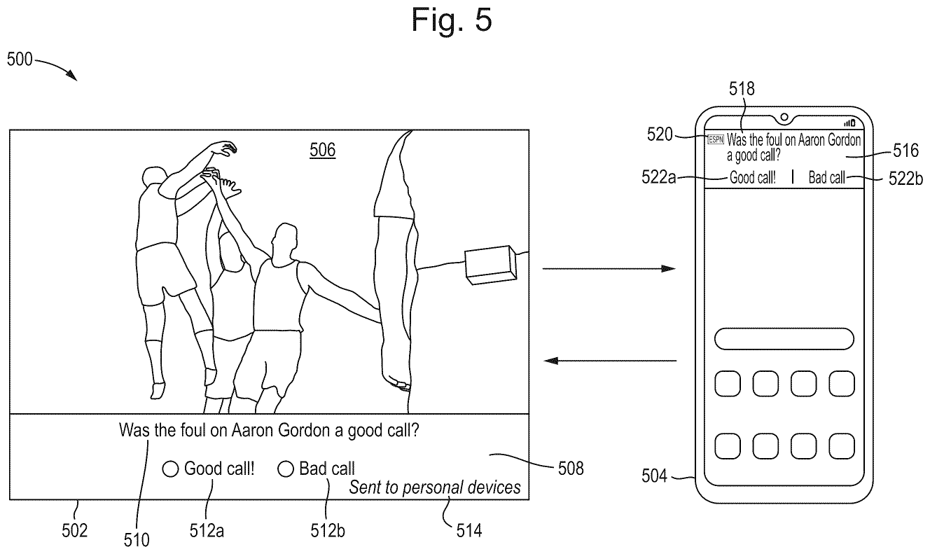

FIG. 5 shows another example user interface for enabling the improved reception of multiple inputs at a user interface in a first configuration, in accordance with some embodiments of the disclosure. The environment 500 comprises a first computing device, such as a smart television 502, and a secondary computing device, such as a smartphone 504 or a tablet device, that is in communication with the smart television 502. Although only one smartphone 504 is depicted, any number of secondary computing devices may be in communication with the smart television 502. The smart television 502 generates a content item 506 and a user interface 508 comprising an interactive content item for output. The user interface 508 comprises a query 510, in this example “Was the foul on Aaron Gordon a good call?” that relates to the content item 506 and is based, for example, on accessed metadata associated with the content item 506. The interactive content item comprises first and second user-selectable user interface elements 512a, 512b for indicating a response to the query 510. The user interface 508 also comprises a notification 514 indicating that the query and user interface elements are available on secondary computing devices, such as smartphone 504. An indication of the query 510 and the responses associated with the selectable user interface elements 512a, 512b are transmitted to the smartphone 504. For example, the indication of the query 510 and the responses associated with the selectable user interface elements 512a, 512b may be transmitted via a network, such as the internet, from a server associated with a service provider. In another example, the indication of the query 510 and the responses associated with the selectable user interface elements 512a, 512b may be transmitted from the smart television 502 via a local network to the smartphone 504. At the smartphone 504, a notification 516 is generated for output. The notification comprises a query 518, based on the query 510 shown on the smart television 502, and selectable user interface elements 522a, 522b for responding to the query 518. The notification may also comprise an icon 520 associated with, for example, a content provider. On receiving input, for example a touch event, associated with a user interface element 522a, 522b, the input and an indication of the user may be stored, for example, to a data structure and at least a part of the data structure may be transmitted. The stored input and indication of the user may be transmitted to a server associated with a service provider, or to the smart television, where it is subsequently transmitted to a server associated with a service provider.

The environment 500 depicted in FIG. 5 enables individual users to be queried with custom and/or targeted polling questions, even if an extensive profile of the user has been developed or is known. In some examples, the poll may be customized based on a user profile associated with each identified user, and the poll may be sent to a secondary computing device associated with a user profile (e.g., if a user is logged in to a service at the secondary computing device), such as a smartphone, smart watch, extended reality glasses and/or augmented reality glasses. The environment 500 depicted in FIG. 5 illustrates an example in which multiple users may be viewing a sports event together; however, each identified user may receive a common polling question on their secondary computing device when a polling opportunity is identified.

In this example, the smart television 502 generates a polling question 510 for output while visually notifying 514 the viewers that the poll has been transmitted to their secondary computing devices 504. Simultaneously, each user also receives a push notification 516 on their secondary computing device 504 that is capable of receiving input associated with selectable user interface elements 522a, 522b. Different polling questions may be transmitted to different secondary computing devices 504 based on a profile associated with the secondary computing device and, for example, a template at the survey generation engine 214.

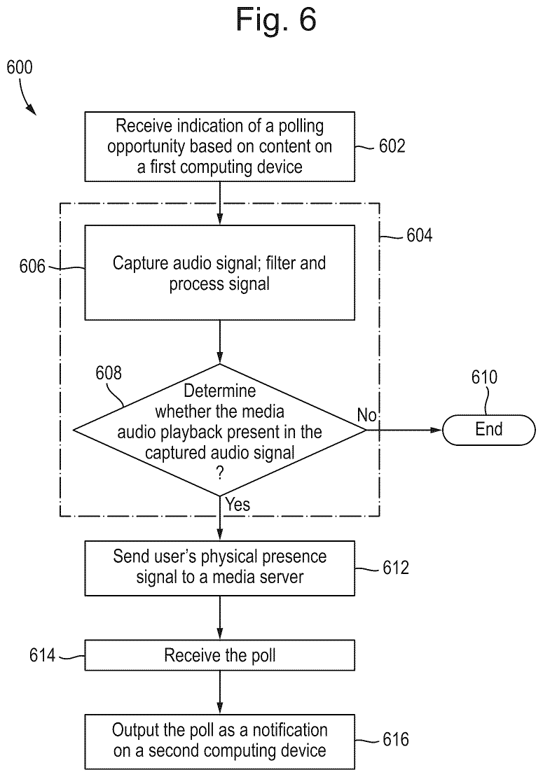

FIG. 6 shows a flowchart of illustrative steps involved in enabling the improved reception of multiple inputs at a user interface, in accordance with some embodiments of the disclosure. Process 600 may be implemented, in whole or in part, on any of the aforementioned computing devices (e.g., computing devices 102, 202, 302, 502, 504 e.g., by way of executing one or more instructions or routines stored in the memory or storage of a device). In addition, one or more actions of the process 600 may be incorporated into or combined with one or more actions of any other process or embodiments described herein.

At 602, an indication of a polling opportunity based on content being output at a first computing device, such as a household television, is received. At 604, a secondary computing device proximity detection technique is performed, in this example, comprising steps 606 and 608. At step 606, an audio signal is captured, for example via a microphone associated with a secondary computing device, and the audio signal is filtered and processed. At 608, it is determined whether media audio playback associated with the content item being output on the first computing device is in the captured audio signal. If the media audio playback associated with the content item being output on the first computing device is not in the captured audio signal (“No” at 608), then the process proceeds to 610 where it ends. If the media audio playback associated with the content item being output on the first computing device is in the captured audio signal (“Yes” at 608), then the process proceeds to 612, where a physical presence signal associated with a user is transmitted to a media service. At 614, a poll (including, for example, metadata and a uniform resource locator (URL)) is received at a secondary computing device, and, at 616, the poll is generated for output as a notification at the secondary computing device (e.g., as a push notification).

There are a number of ways to determine that a user associated with a secondary computing device 504 is within viewing distance of the smart television 502 that is generating the content item 506 for output. For example, each user in a household associated with the content service may have the content service application running on their secondary computing device 504. A content service 212 may determine whether a secondary computing device 504 associated with an account at a fixed location, such as a household, has a public IP address that matches the fixed location IP address. For example, the content service 212 may select only the devices that match the fixed location IP address, to filter the set of secondary computing devices 504 to those users that are currently at the fixed location. When the content service 212 detects a polling opportunity arising from content output at the smart television 502, the content service 212 may pass this message to the filtered list of secondary computing devices 504 in the fixed location.

A fixed-location account, such as a household account, may be associated with the smart television 502 and a secondary computing device 504, and the secondary computing device 504 may receive an indication of a polling opportunity 602. In response to receiving this indication of a polling opportunity, an audio analysis engine associated with the secondary computing device 504 may capture audio 606 via a microphone (typically running as a background process) associated with the secondary computing device 504. The secondary computing device 504 may then process this audio signal and analyzes it to determine 608 whether the audio signature of the media that is being currently played on the smart television 502 is present. This analysis may be performed on the secondary computing device, or the audio signal from the secondary computing device 504 may be transmitted to another computing device that runs the audio analysis engine, such as a smart television, set-top box, or a cloud server. Once the determination is made that the audio signal of the content item being output at the smart television 502 is present in the secondary computing device 504 audio capture, the system concludes that the secondary computing device 504 is in vicinity of the smart television 502, and the user associated with the secondary computing device 504 is likely consuming the content 506 being output at the smart television 502. The audio analysis engine (whether on a secondary computing device, set-top box or cloud server) then proceeds to transmit 612 a physical presence signal to the survey generation service 214, and receives 614 a poll from the survey generation service 214 either as, for example, metadata or as a URL. This poll is then generated for output 616 at the secondary computing device 504 (e.g., as a push notification) and the received input associated with the poll is transmitted back (not shown) to the survey generation service 214. The polling service 214 may then communicate the received input to the content service 212 (for example, in an individualized or aggregated manner).

In place of, or in addition to, the audio capture technique described above, other proximity detection techniques may also, or alternatively, be utilized. For example, a received signal strength indicator (RSSI) of a Wi-Fi signal associated with the smart television 502 may be measured by a secondary computing device 504, and vice versa, to determine that they are within a threshold vicinity (such as, for example, an RSSI>−40 db, or any other suitable empirically determined value can be used). In another example, a peer-to-peer protocol, such as Bluetooth, or Wi-Fi Direct (for example, a peer-to-peer mode for Wi-Fi devices and/or neighbor aware networking) may also be utilized to exchange hello packets in a low power transmission mode. Successful receipt of these packets may be utilized to determine that the smart television 502 and the secondary computing device 504 are in the vicinity of each other.

In some examples, a content service 212 may require a user to fill in a questionnaire comprising questions relating to user characteristics such as age and/or gender when they download an application associated with the content service onto their secondary computing device 504. In further examples, advanced computer vision artificial intelligence and/or machine learning models may also be used with camera and/or microphone inputs associated with the secondary computing device 504 to populate a user's identification and/or demographic characteristics. This helps the content service 212 to create a profile for each user associated with a content service account. The content service 212 may also keep track of the viewing habits associated with a profile in an account associated with a fixed location, such as a household, that this user employs when they consume content on a secondary computing device 504. This further enables the content service 212 to develop an advanced profile for each user associated with the content service account.

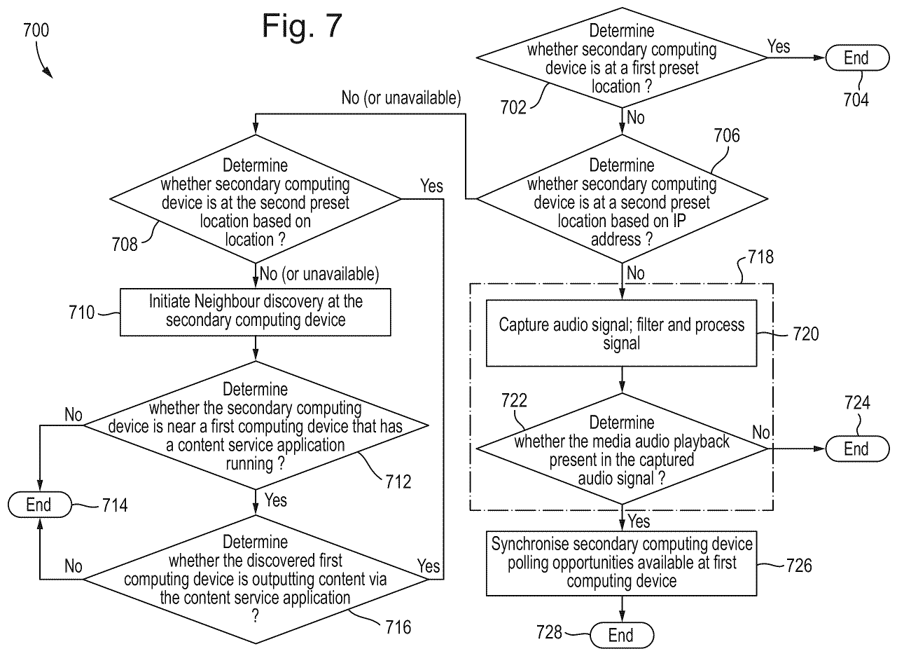

FIG. 7 shows another flowchart of illustrative steps involved in enabling the improved reception of multiple inputs at a user interface, in accordance with some embodiments of the disclosure. Process 700 may be implemented, in whole or in part, on any of the aforementioned computing devices (e.g., computing devices 102, 202, 302, 502, 504 e.g., by way of executing one or more instructions or routines stored in the memory or storage of a device). In addition, one or more actions of the process 700 may be incorporated into or combined with one or more actions of any other process or embodiments described herein.

Process 700 may be beneficial when a user is watching, or consuming, content on a primary computing device, such as a television, in a location other than their primary location, also referred to as their first preset location. At 702, it is determined whether a secondary computing device, such as a smartphone and/or tablet, is at a first preset location such as, for example, a home location, via an IP address associated with the secondary computing device and/or a positioning service, such as a global positioning service (GPS). If, at step 702, it is determined that the secondary computing device is at the first preset location, then the process proceeds to step 704, where the process ends. In addition (not shown), the audio capture and comparison method described in connection with FIG. 6, or another proximity detection method, may be used to validate that the user is watching, or consuming, the content at step 704. If the user is watching, or consuming, content, the secondary computing device may be served with surveys or polls associated with the content on the primary computing device. If, at step 702, it is determined that the secondary computing device is not at the first preset location, then the process proceeds to step 706. At 706, it is determined whether the secondary computing device is at a second preset location, such as, for example, another known household, based on an IP address associated with the secondary computing device.

If, at step 706, it is determined that the secondary computing device is not at a second preset location, or it cannot be determined, based on the IP address, then, at 708, it is determined whether the secondary computing device is present at the second preset location based on a position service, such as a GPS. If, at step 706, it is determined that the computing device is present at the second preset location, the process proceeds to step 720. If, at step 708, it is determined that the computing device is not present at the second preset location, or it cannot be determined, based on the location service, then the process proceeds to step 710. At 710, neighbor discovery is initiated at the secondary computing device. At 712, it is determined whether the secondary computing device is near a first computing device, such as a smart television, that has a content service application running. If, at 712, it is determined that the secondary computing device is not near a first computing device that has a content service application running, the process proceeds to step 714, where the process ends. If, at 712, it is determined that the secondary computing device is near a first computing device that has a content service application running, the process proceeds to step 716.

At 716, it is determined whether the discovered first computing device is outputting a content item via the content service application. If, at step 716, it is determined that the first computing device is not outputting a content item via the content service application, then the process proceeds to step 714, where the process ends, without identifying a primary computing device on which content is being consumed in the proximity to the secondary computing device. If, at step 716, it is determined that the first computing device is outputting a content item via the content service application, then the process proceeds to step 720.

If, at step 706, it is determined that the secondary computing device is at a second preset location based on the IP address, then, at 718, a secondary computing device proximity detection technique is performed, in this example, comprising steps 720 and 722. At step 720, an audio signal is captured, for example via a microphone associated with the secondary computing device, and the audio signal is filtered and processed to determine. At 722, it is determined whether media audio playback associated with the content item being output on the first computing device is in the captured audio signal. If the media audio playback associated with the content item being output on the first computing device is not in the captured audio signal (“No” at 722), then the process proceeds to 724 where it ends. If the media audio playback associated with the content item being output on the first computing device is in the captured audio signal (“Yes” at 722), then the process proceeds to 726, where the secondary computing device is synchronized with polling opportunities available at the first computing device.

In some examples, a user from a separate preset location, such as a household, who subscribes to a content service may consume content not at their own home, but at a friend's home (i.e., a second preset location). The content service may, for example, store a location and an IP address associated with a preset location, such as each identified household. In one example, the location may be GPS coordinates obtained via a secondary computing device, such as a smartphone and/or tablet, associated with a household account while that user is determined to be consuming content in their home (i.e., the secondary device is associated with the home IP address). In other examples, address-based lookup may also be used to record the location of the household.

In an example, when a guest viewer is consuming content with members of another preset location, such as a household, then the system may determine a specific host household, and whether this user is consuming content in that household. This enables the system to transmit polls or bets to a secondary device associated with the user, even if they are a guest in another household. For example, the IP address and/or a location associated with the secondary computing device may be used to determine the likely presence of this user in another household location. If, for example, the guest viewer has joined the network, such as a Wi-Fi network, of another host household (or preset location), then the IP address may be used to determine that they are at this household's location. If the IP address does not match, then a location service, such as GPS, may be used to determine whether the guest is at another (host) household's location. If location information is not available, then the secondary computing device may perform discovery of primary computing devices, such as smart televisions, in their neighborhood that are currently outputting content using proximity detection such as Wi-Fi Direct and/or Bluetooth beaconing. In an example, the secondary computing device may utilize an application-level exchange of information, via a content service application running on the computing device, to discover another primary computing device that is also running the content service application. This information may then be transmitted to the content service provider to determine whether the primary computing device is currently outputting a content item from the content service. After a determination is made that the user is a guest in another household with a primary computing device actively outputting a content item, audio is captured at a secondary computing device associated with the user and is compared with the primary computing device content item audio. If the audio signature of the primary computing device content item is present in the guest user's secondary computing device audio capture, then the system infers that this user is a consumer of the content item as a guest in another (host) household. Thus, the content service is also able to synchronize polls via the secondary computing device associated with this user based on the host household account even though the user is not present in their home (or other preset) location.

In some examples, the proximity detection methods (e.g., audio capture, Wi-Fi RSSI, Wi-Fi direct communication and/or Bluetooth beaconing, etc.) may be used in combination with the technique of using a capture device associated with a computing device, such as a camera associated with a smart television, to determine the number of users and/or the identities and or user profiles of the users. For example, the likely identities of viewers may be determined via a capture device, while the audio capture may be utilized to confirm the presence of users in the vicinity of the computing device. If a user is partially captured in a capture, such as an image, or the system is not able to determine a user's identity and/or profile via a capture, the content service may use the audio capture, or other proximity detection technique, on another user's device with an IP address and/or location, such as a GPS location, that matches the household, or a preset location, to determine which of them is potentially consuming a content item at the computing device.

In some examples, an audio capture device, such as a microphone, associated with a computing device may be utilized to collect responses to a poll. Using an audio capture device may enable free-form responses to be received and stored, such as an answer to the query “Describe why you like this product.” In some embodiments, the microphone of a voice assistant system (VAS) may be co-opted to record user feedback to polling questions. In some examples, instead of performing a presence test by comparing an audio capture on a secondary computing device to the currently playing audio of a content item on a primary computing device, or on a media server, the audio capture on the secondary computing device may be compared to the audio capture from a voice assistant system device in the household that is known to be close to a primary computing device, such as a smart television (through, for example, periodic performance of an audio capture test when the primary computing device is outputting content items). In an example, the data from the voice assistant may be used to refine the household's profile over time (e.g., by determining the ratio of male to female users in the household, or by using registered voice prints to identify specific individuals). For example, if one of the viewers elected to responding through the VAS and the other users did not, then the response communicated to the survey module may indicate which user in the household responded (if such privacy settings are enabled and authorized by the user). For example, an indication may be “female,” or “22-28-year-old male.” Such information may be based on the respondent's voiceprint and/or identified using audio analysis techniques. In one example, free-form comments may be posted back as reviews on a user's profile page associated with, for example, an ecommerce site and/or a social media site. In some examples, the comments may only be posted if the user is a verified buyer of such product. For example, an advertisement may depict a Lenovo laptop and text comprising a free-form response from a viewer, which may be a review of such product on Amazon, Best Buy and/or Google. An identification of the product depicted in the advertisement and/or other metadata may be compared to the user purchase profile in order to determine whether the user bought the product. This may be possible when an account associated with the primary computing device, such as a smart television and/or an application running on the smart television, is also associated with, for example, an ecommerce and/or social media account (e.g., Google shopping and Google TVs). In other examples, a user may be able link their ecommerce account and/or social network account to the survey service. Free-form responses may be used to determine a general sentiment in absence of, or in connection to, explicit feedback (e.g., a rating of “four stars”).

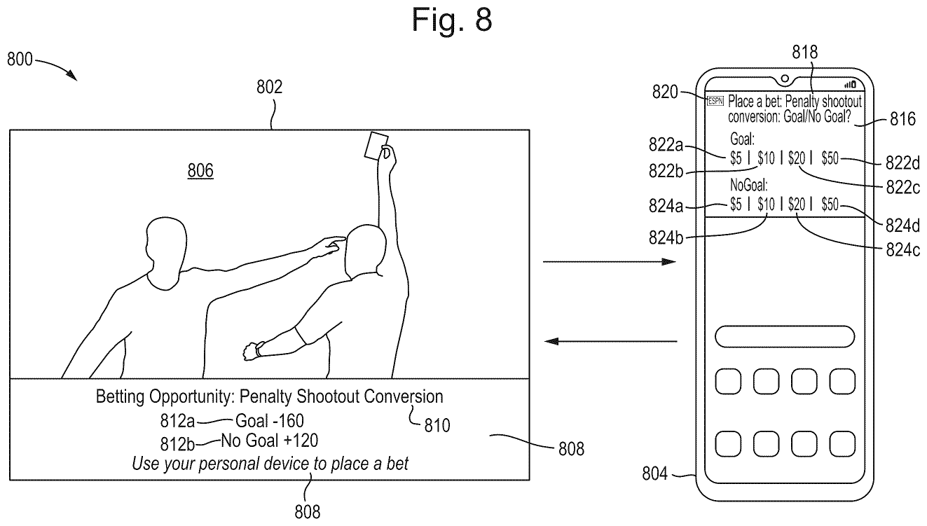

FIG. 8 shows another example user interface for enabling the improved reception of multiple inputs at a user interface in a first configuration, in accordance with some embodiments of the disclosure. The environment 800 comprises a first computing device, such as a smart television 802 and a secondary computing device, such as a smartphone 804 or a tablet device, that is in communication with the smart television 802. Although only one smartphone 804 is depicted, any number of secondary computing devices may be in communication with the smart television 802. The smart television 802 generates a content item 806 and a user interface 808 comprising an interactive content item for output. The user interface 808 comprises a query 810, in this example “Betting Opportunity: Penalty Shootout Conversion,” that relates to the content item 806 and is based, for example, on accessed metadata associated with the content item 806. The interactive content item comprises first and second user selectable user interface elements 812a, 812b for indicating a response to the query 810. The user interface 808 also comprises a notification 814 indicating that the query and user interface elements are available on secondary computing devices, such as smartphone 804. An indication of the query 810 and the responses associated with the selectable user interface elements 812a, 812b are transmitted to the smartphone 804. For example, the indication of the query 810 and the responses associated with the selectable user interface elements 812a, 812b may be transmitted via a network, such as the internet, from a server associated with a service provider. In another example, the indication of the query 810 and the responses associated with the selectable user interface elements 812a, 812b may be transmitted from the smart television 802 via a local network to the smartphone 804. At the smartphone 804, a notification 816 is generated for output. The notification comprises a query 818, based on the query 810 shown on the smart television 802, and user selectable interface elements 822a-d, 824a-d for responding to the query 818. The notification may also comprise an icon 820 associated with, for example, a content provider. On receiving input, for example a touch event, associated with a user interface element 822a-d, 824a-d, the input and an indication of the user may be stored, for example, to a data structure and at least a part of the data structure may be transmitted. The stored input and indication of the user may be transmitted to a server associated with a service provider, or to the smart television, where it is subsequently transmitted to a server associated with a service provider.

The environment 800 depicted in FIG. 8 illustrates an example where push notifications 816 are output at secondary computing devices 804 (only one of which is shown). The push notifications 816 enable input to be received for placing bets, even as multiple individuals are watching a content item 806, such as a game, on the same smart television 802. With reference to FIG. 2, it is assumed that the betting service 222 and the content service 212 have an agreement and an API that enables the betting service 222 to transmit a bet to the smart television 802 and/or the secondary computing devices 804 via the content service 212, even as the content service 212 provides a channel to the betting service 222 to deliver the bet to users, via their associated secondary computing devices 204, who are consuming a content item 806 on a smart television 802. A betting opportunity is transmitted to smart television 802, where it is generated for output. The user may have registered a priori with the betting service 222 and may have approved the linking of the betting service 222 with the content service 212 using a known authorization protocol such as open authentication (OAuth) 2.0. As more than one user may be consuming the content item 806 at the smart television 802 at the same time, the system may enable the viewers to place the bets on secondary computing devices 804 associated with each of the viewers. A secondary computing device 804 may generate a push notification 816 for output that enables one-touch betting for a registered user. The stake amounts may be pre-configured by the user on the betting platform 222 (or, in some examples, on the content service 212 acting as proxy). The aforementioned methods of using a capture device and an audio device associated with the smart television 802 may be employed to ensure that the betting opportunity is presented to a user who is watching the game, and that they can bet privately, i.e., via the secondary computing device 804 associated with them.

In some examples, the content service 212 may be replaced by a connected television service (or smart television service) that is independent from the content service 212. In this example, the connected television service may have arrangements with a survey generation service 214 or a betting service 222 to deliver interactive content to the smart television 802. Since the connected television service may not have a priori knowledge of a specific content ID associated with a content item that is currently playing, the connected television service may utilize automatic content recognition (ACR) to identify a content item that is being generated for output at the smart television 802. Furthermore, in some examples, ACR may also be used to determine a specific time instant of the content item, and thus may be used as an input to a system that determines a polling or betting opportunity.

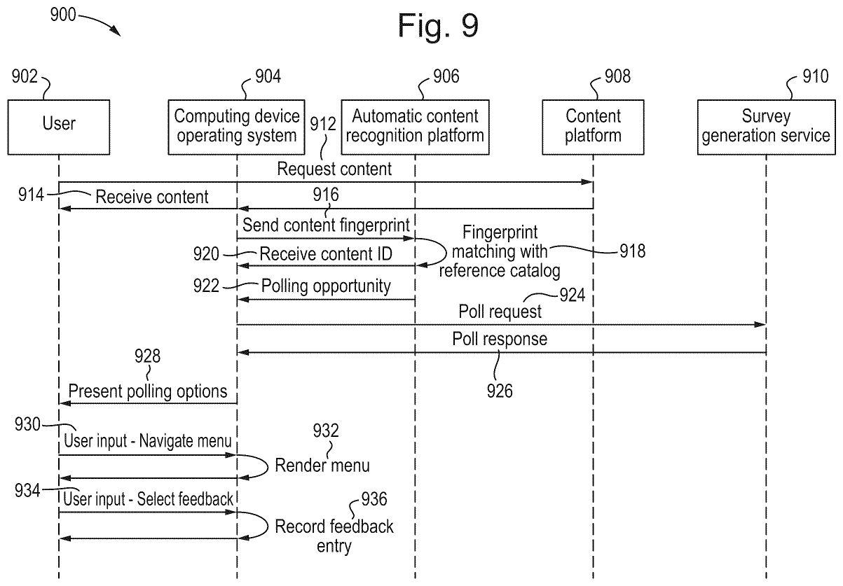

FIG. 9 shows another flowchart of illustrative steps involved in enabling the improved reception of multiple inputs at a user interface, in accordance with some embodiments of the disclosure. Process 900 may be implemented, in whole or in part, on any of the aforementioned computing devices (e.g., computing devices 102, 202, 302, 502, 504, 802, 804 e.g., by way of executing one or more instructions or routines stored in the memory or storage of a device). In addition, one or more actions of the process 900 may be incorporated into or combined with one or more actions of any other process or embodiments described herein.

A user 902 requests 912 content from a content platform 908, and the user receives 914 the content from the content platform 908. A content fingerprint is sent 916 from a computing device operating system 904, such as a connected television or smart television operating system, to an ACR platform 906. At the ACR platform 906, fingerprint matching 918 with a reference catalogue is performed to generate a content ID. The content ID is received 920 at the computing device operating system 904, from the ACR platform 906. In addition, a polling opportunity 922 is transmitted from the ACR platform 906 to the computing device operating system 904. The computing device operating system 904 requests 924 a poll from a survey generation service 910, and, in response, the survey generation service 910 transmits the poll request response 926 to the computing device operating system 904. The computing device operating system 904 presents 928 (e.g., generated for output) the polling options to the user 902. Input is received at the computing device operating system 904 to navigate 930 a menu, the menu is rendered 932, and the rendered menu is presented to the user 902 (e.g., generated for output). Input is received at the computing device operating system 904 to select 934 feedback, and the feedback is recorded 936.

After receiving a content ID from an ACR platform 906, computing device operating system 904 waits for a polling (or betting) opportunity. When the ACR platform 906 signals a polling (or betting) opportunity, the computing device operating system 904 requests a poll from the survey generation engine 910. For betting examples, the betting engine may be in contact with the ACR platform 906 or its own computation engine to determine a betting opportunity.

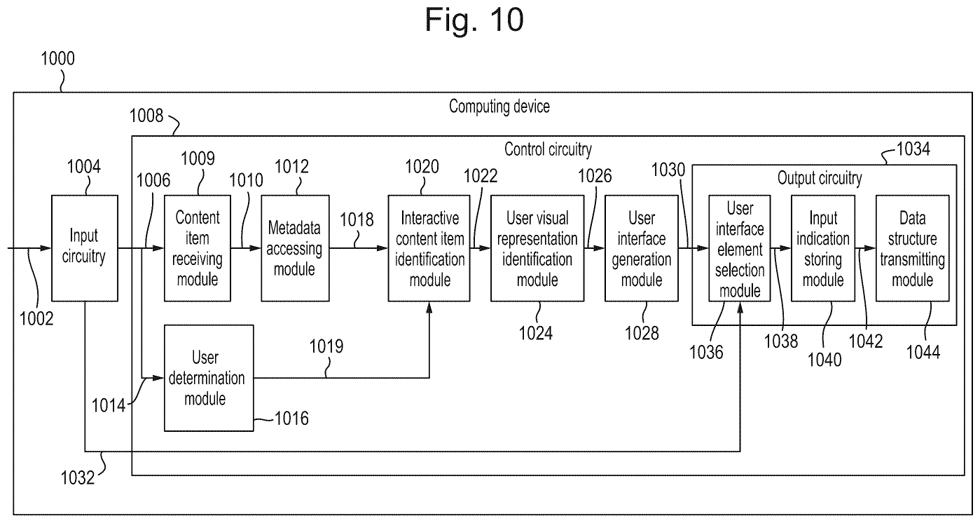

FIG. 10 shows a block diagram representing components of a computing system, and dataflow therebetween, for enabling the improved reception of multiple inputs at a user interface, in accordance with some embodiments of the disclosure. Computing device 1000 comprises input circuitry 1004, control circuitry 1008 and output circuitry 1034. Control circuitry 1008 may be based on any suitable processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 888). Some control circuits may be implemented in hardware, firmware, or software.

Input is received 1002 by the input circuitry 1004. The input circuitry 1004 is configured to receive inputs related to a computing device. For example, this may be via an infrared controller, a Bluetooth controller and/or Wi-Fi controller of the computing device 1000. In another example, the inputs may be received via a secondary computing device, such as a smartphone and/or tablet device. In some examples, the inputs may be received via a touchscreen of the computing device, a keyboard, a mouse and/or a microphone. In another example, the inputs may be received via a gesture detected at a touchscreen and/or an extended reality device. The input circuitry 1004 transmits 1006 the user input to the control circuitry 1008.

The control circuitry 1008 comprises a content item receiving module 1009, a metadata accessing module 1012, a user determination module 1016, an interactive content item identification module 1020, a user visual representation identification module 1024, a user interface generation module 1028, and output circuitry 1034 comprising a user interface element selection module 1036, an input indication storing module 1040 and a data structure transmitting module 1044.

The input is transmitted 1006 from the input circuitry 1004 to the content item receiving module 1009, where a content item is received. An indication of the received content item is transmitted 1010 to the metadata accessing module 1012, where metadata associated with the content item is accessed. The input is also transmitted 1014 to the user determination module 1016, where a number of users proximate to the computing device 1000 are identified. The accessed metadata is transmitted 1018 to the interactive content item identification module 1020, and the identified number of users is also transmitted 1019 to the interactive content item identification module 1020, where an interactive content item is identified based on the accessed metadata and the identified number of users. The identified interactive content item is transmitted 1022 to the user visual representation identification module 1024, where a visual representation of the identified users is accessed. The identified interactive content item and the visual representation of the users are transmitted 1026 to the user interface generation module, where a user interface comprising the identified interactive content item, the visual representation of the users and a plurality of user interface elements associated with each of the identified users is generated. The generated user interface is transmitted 1030 to the output circuitry 1034, where the user interface element selection module 1036 generates the user interface for output. Input associated with a subset of the plurality of user interface elements is received via the input circuitry 1004 and is transmitted 1032 to the user interface element selection module 1036. An indication of the selected user interface elements and a user that they are associated with is transmitted 1038 to the input indication storing module 1040, where it is optionally stored in a data structure. The stored data is transmitted 1042 to the data structure transmitting module 1044 where at least a part of the stored data is transmitted, for example to an external server via a network such as the internet.

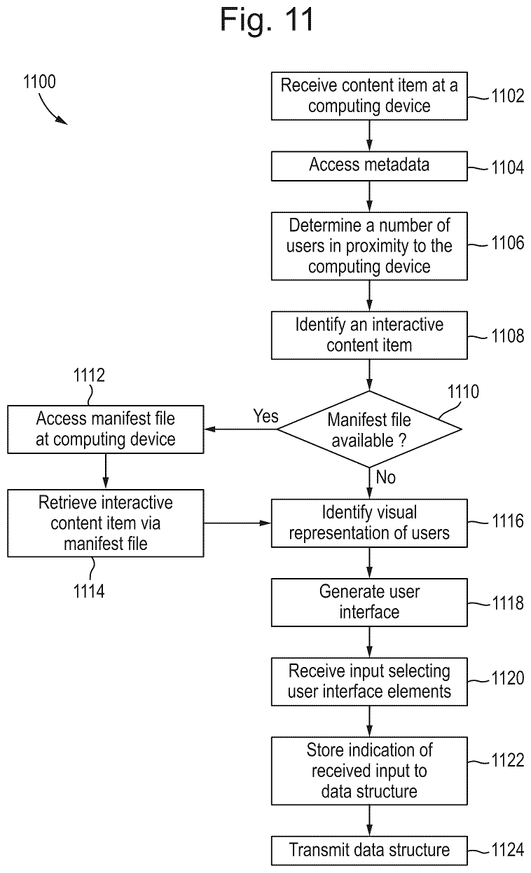

FIG. 11 shows another flowchart of illustrative steps involved in enabling the improved reception of multiple inputs at a user interface, in accordance with some embodiments of the disclosure. Process 1100 may be implemented, in whole or in part, on any of the aforementioned computing devices (e.g., computing devices 102, 202, 302, 502, 504, 802, 804, 1000 e.g., by way of executing one or more instructions or routines stored in the memory or storage of a device). In addition, one or more actions of the process 1100 may be incorporated into or combined with one or more actions of any other process or embodiments described herein.

At 1102, a content item is received at a computing device, and at 1104 metadata associated with the content item is accessed. At 1106, a number of users in proximity to the computing device is identified, and at 1108, an interactive content item is identified. At 1110, it is determined whether a manifest file associated with the identified interactive content item is available. If a manifest file is available, then the process proceeds to step 1112. At 1112, the manifest file is accessed at the computing device, and at 1114, the identified interactive content item is retrieved via the manifest file, for example, via a URL indicated in the manifest file. At 1116, a visual representation of the users is accessed, and at 1118, a user interface is generated. At 1120, input selecting a user interface element associated with each identified user is received, and at 1122, an indication of the received input and the user associated with the received input are stored, for example, in a data structure. At 1124, at least a part of the stored data, for example, at least a part of the data structure, is transmitted, for example, to an external server via a network such as the internet.

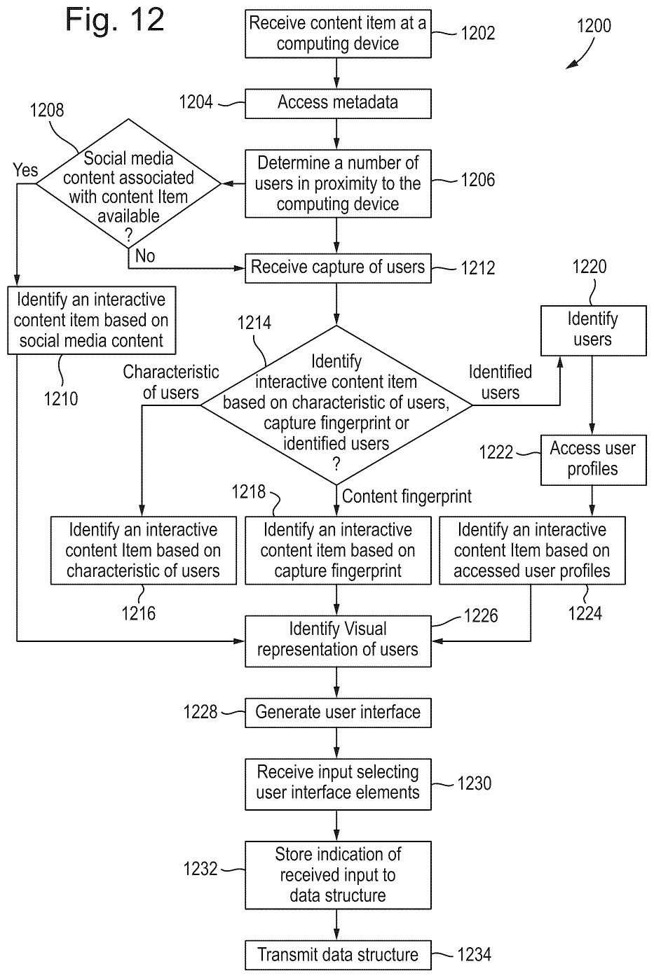

FIG. 12 shows another flowchart of illustrative steps involved in enabling the improved reception of multiple inputs at a user interface, in accordance with some embodiments of the disclosure. Process 1200 may be implemented, in whole or in part, on any of the aforementioned computing devices (e.g., computing devices 102, 202, 302, 502, 504, 802, 804, 1000 e.g., by way of executing one or more instructions or routines stored in the memory or storage of a device). In addition, one or more actions of the process 1200 may be incorporated into or combined with one or more actions of any other process or embodiments described herein.

At 1202, a content item is received at a computing device, and at 1204 metadata associated with the content item is accessed. At 1206, a number of users in proximity to the computing device is identified. At 1208, it is determined, based on the accessed metadata, whether social media content associated with the content item is available. If social media content associated with the content item is available, the process proceeds to step 1210, where an interactive content item is identified based on the identified number of users and the social media content, and the process then proceeds to step 1226. If, at step 1208, it is determined, based on the accessed metadata, that social media content associated with the content item is not available, then the process proceeds to step 1212.

At step 1212, a capture of the identified users is received, and at 1214, it is identified whether an interactive content item is to be identified based on a characteristic of users in the capture, a fingerprint of the capture, or users identified in the capture. If the content item is to be identified based on a characteristic of users in the capture, then the process proceeds to step 1216, where an interactive content item is identified based on the identified number of users and one or more identified characteristics of the users in the received capture, and the process then proceeds to step 1226. If the content item is to be identified based on a fingerprint of the capture, then the process proceeds to step 1218, where an interactive content item is identified based on the identified number of users and a fingerprint of the received capture, and the process then proceeds to step 1226. If the content item is to be identified based on users identified in the capture, then the process proceeds to step 1220, where users in the capture are identified. Then, at step 1222, user profiles associated with the identified users are accessed, and at step 1224, an interactive content item is identified based on the identified number of users and the accessed user profiles, and the process then proceeds to step 1226.

At step 1226, a visual representation of the identified users is accessed, and at 1228, a user interface is generated. At 1230, input selecting a user interface element associated with each identified user is received, and at 1232, an indication of the received input and the user associated with the received input are stored, for example, in a data structure. At 1234, at least a part of the stored data, for example, at least a part of the data structure, is transmitted, for example, to an external server via a network such as the internet.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, at a computing device, a content item;
accessing metadata associated with the content item;
determining a number of one or more users that are in proximity to the computing device;
identifying, based on the metadata and the number of users, an interactive content item;
accessing a visual representation of the one or more users;
generating, for output, a user interface comprising:
the interactive content item, wherein the interactive content item comprises at least one user interface element associated with each user; and
the visual representation of the one or more users;
receiving an input selecting a user interface element associated with each user;
storing, to a data structure, an indication of the received input and the user with whom the input is associated; and
transmitting at least a part of the data structure.

2. The method of claim 1, further comprising:
generating a manifest file comprising a link to the interactive content item;
transmitting the manifest file to the computing device;
accessing, at the computing device, the manifest file; and
retrieving, via the link, the interactive content item.

3. The method of claim 1, wherein:
the method further comprises:
receiving, at the computing device, a capture of the one or more users; and
determining a respective characteristic associated with each of the one or more users; and
identifying the interactive content item further comprises identifying the interactive content item based on the determined respective characteristics associated with the one or more users.

4. The method of claim 1, wherein:
the method further comprises:
receiving, at the computing device, a capture of the one or more users; and
generating, based on the capture, a fingerprint associated with the capture; and
identifying the interactive content item further comprises identifying the interactive content item based on the fingerprint.

5. The method of claim 1, wherein:
the method further comprises:
identifying one or more of the users; and
accessing one or more user profiles, each user profile associated with a respective user of the one or more identified users; and
identifying the interactive content item further comprises identifying the interactive content item based on the at least one of the accessed user profiles.

6. The method of claim 1, further comprising:
determining one more users in the visual representation;
applying a unique indicator to each determined user in the visual representation; and
for each determined user, applying a corresponding indicator to at least one of the one or more user interface elements associated with that user.

7. The method of claim 1, wherein:
the method further comprises identifying, based on the metadata, social media content associated with the content item; and
identifying the interactive content item further comprises identifying the interactive content item based on the social media content.

8. The method of claim 1, wherein:
the method further comprises identifying one or more of the users;
the method further comprises accessing one or more user profiles, each user profile associated with a respective user of the one or more identified users;
the method further comprises identifying, for each accessed user profile, an associated computing device;
for each associated computing device that is associated with an accessed user profile and respective user, generating the user interface for output further comprises:
transmitting, to the associated computing device, the at least one user interface element associated with the user; and
generating for output, at the associated computing device, the user interface comprising the user interface element associated with the user; and
receiving an input selecting a user interface element associated with each user further comprises receiving, at the associated computing device, an input associated with selecting a user interface element associated with the user.

9. The method of claim 8, further comprising:
capturing, via a microphone of an associated computing device, ambient audio;
identifying audio associated with the content item;
comparing the captured ambient audio to the audio associated with the content item;
identifying, based on the comparing, that the captured ambient audio comprises the audio associated with the content item; and
determining that the associated computing device is in proximity to the computing device in response to identifying that the captured ambient audio comprises the audio associated with the content item.

10. The method of claim 8, further comprising generating, for output at the computing device, a user interface element indicating an opportunity for the one or more users to interact with an associated computing device.

11. A system comprising:
input/output circuitry configured to:
receive, at a computing device, input requesting a content item;
processing circuitry configured to:
receive, at the computing device, the content item;
access metadata associated with the content item;
determine a number of one or more users that are in proximity to the computing device;
identify, based on the metadata and the number of users, an interactive content item;
access a visual representation of the one or more users;
generate, for output, a user interface comprising:
the interactive content item, wherein the interactive content item comprises at least one user interface element associated with each user; and
the visual representation of the one or more users;
receive an input selecting a user interface element associated with each user;
store, to a data structure, an indication of the received input and the user with whom the input is associated; and
transmit at least a part of the data structure.

12. The system of claim 11, wherein the processing circuitry is further configured to:
generate a manifest file comprising a link to the interactive content item;
transmit the manifest file to the computing device;
access, at the computing device, the manifest file; and
retrieve, via the link, the interactive content item.

13. The system of claim 11, wherein:
the processing circuitry is further configured to:
receive, at the computing device, a capture of the one or more users; and
determine a respective characteristic associated with each of the one or more users; and
the processing circuitry configured to identify the interactive content item is further configured to identify the interactive content item based on the determined respective characteristics associated with the one or more users.

14. The system of claim 11, wherein:
the processing circuitry is further configured to:
receive, at the computing device, a capture of the one or more users; and
generate, based on the capture, a fingerprint associated with the capture; and
the processing circuitry configured to identify the interactive content item is further configured to identify the interactive content item based on the fingerprint.

15. The system of claim 11, wherein:
the processing circuitry is further configured to:
identify one or more of the users; and
access one or more user profiles, each user profile associated with a respective user of the one or more identified users; and
the processing circuitry configured to identify the interactive content item is further configured to identify the interactive content item based on the at least one of the accessed user profiles.

16. The system of claim 11, wherein the processing circuitry is further configured to:
determine one or more users in the visual representation;
apply a unique indicator to each determined user in the visual representation; and
for each determined user, apply a corresponding indicator to at least one of the one or more user interface elements associated with that user.

17. The system of claim 11, wherein:
the processing circuitry is further configured to identify, based on the metadata, social media content associated with the content item; and
the processing circuitry configured to identify the interactive content item is further configured to identify the interactive content item based on the social media content.

18. The system of claim 11, wherein:
the processing circuitry is further configured to identify one or more of the users;
the processing circuitry is further configured to access one or more user profiles, each user profile associated with a respective user of the one or more identified users;
the processing circuitry is further configured to identify, for each accessed user profile, an associated computing device;
for each associated computing device that is associated with an accessed user profile and respective user, the processing circuitry configured to generate the user interface for output is further configured to:
transmit, to the associated computing device, the at least one user interface element associated with the user; and
generate for output, at the associated computing device, the user interface comprising the user interface element associated with the user; and
the processing circuitry configured to receive an input selecting a user interface element associated with each user is further configured to receive, at the associated computing device, an input associated with selecting a user interface element associated with the user.

19. The system of claim 18, wherein the control circuitry is further configured to:
capture, via a microphone of an associated computing device, ambient audio;
identify audio associated with the content item;
compare the captured ambient audio to the audio associated with the content item;
identify, based on the comparing, that the captured ambient audio comprises the audio associated with the content item; and
determine that the associated computing device is in proximity to the computing device in response to identifying that the captured ambient audio comprises the audio associated with the content item.

20. The system of claim 18, wherein the processing circuitry is further configured to generate, for output at the computing device, a user interface element indicating an opportunity for the one or more users to interact with an associated computing device.

21-50. (canceled)
